(19) United States
(12) Patent Application Publication
(10) Pub. No.: US 2025/0200733 A1
(43) Pub. Date: Jun. 19, 2025

(54) VIDEO QUALITY EVALUATION METHOD AND APPARATUS, DEVICE AND STORAGE MEDIUM

(71) Applicant: Beijing Zitiao Network Technology Co., Ltd., Beijing (CN)

(72) Inventors: Tianwu ZHI, Beijing (CN); Li YANG, Beijing (CN); Yabin ZHANG, Beijing (CN)

(21) Appl. No.: 18/955,239

(22) Filed: Nov. 21, 2024

(30) Foreign Application Priority Data
Dec. 18, 2023 (CN) 202311747431.X

(51) Int. Cl. G06T 7/00

(52) U.S. Cl. CPC G06T 7/0002; G06T 2207/20132

(57) ABSTRACT

Embodiments of the present disclosure provide a video quality evaluation method, an apparatus, a device, and a storage medium. The method includes: performing frame sampling on a target video to obtain a plurality of video frames; cropping at least one sub-image out of each of the plurality of video frames to obtain a plurality of video sub-images; inputting the plurality of video sub-images respectively into a quality evaluation model to output quality evaluation sub-information respectively corresponding to the video sub-images, wherein the quality evaluation model comprises a self-attention network with a moving window; and fusing the quality evaluation sub-information respectively corresponding to the video sub-images to obtain quality evaluation information corresponding to the target video.

### CROSS-REFERENCE TO RELATED APPLICATION(S)

This application claims priority to Chinese Application No. 202311747431.X filed in December 18, 2023, the disclosures of which are incorporated herein by reference in their entities.

### FIELD

The present disclosure relates to the technical field of multimedia data processing technology, in particular to a video quality evaluation method, an apparatus, a device, and a storage medium.

### SUMMARY

The embodiments of the present disclosure provide a video quality evaluation method, an apparatus, a device, and a storage medium.

In a first aspect, embodiments of the present disclosure provide a video quality evaluation method, comprising:
performing frame sampling on a target video to obtain a plurality of video frames;
cropping at least one sub-image out of each of the plurality of video frames to obtain a plurality of video sub-images;
inputting the plurality of video sub-images respectively into a quality evaluation model to output quality evaluation sub-information respectively corresponding to the video sub-images, wherein the quality evaluation model comprises a self-attention network with a moving window; and
fusing the quality evaluation sub-information respectively corresponding to the video sub-images to obtain quality evaluation information corresponding to the target video.

In a second aspect, the embodiments of the present disclosure provide a video quality evaluation apparatus, comprising:
a frame sampling module for performing frame sampling on a target video to obtain a plurality of video frames;
a video frame cropping module for cropping at least one sub-image out of each of the plurality of video frames to obtain a plurality of video sub-images;
a quality evaluation sub-information obtaining module for inputting the plurality of video sub-images respectively into a quality evaluation model to output quality evaluation sub-information respectively corresponding to the video sub-images, wherein the quality evaluation model comprises a self-attention network with a moving window; and
a quality evaluation information obtaining module for fusing the quality evaluation sub-information respectively corresponding to the video sub-images to obtain quality evaluation information corresponding to the target video.

In a third aspect, the embodiments of the present disclosure provide an electronic device, comprising:
one or more processors; and
a memory configured to store one or more programs;
wherein the one or more programs, when executed by the one or more processors, cause the one or more processors to implement the video quality evaluation method according to the embodiments of the present disclosure.

In a fourth aspect, the embodiments of the present disclosure provide a storage medium comprising computer executable instructions, which, when executed by a computer processor, implement the video quality evaluation method according to the embodiments of the present disclosure.

Embodiments of the present disclosure provide a video quality evaluation method, an apparatus, a device, and a storage medium. The method includes: performing frame sampling on a target video to obtain a plurality of video frames; cropping at least one sub-image out of each of the plurality of video frames to obtain a plurality of video sub-images; inputting the plurality of video sub-images respectively into a quality evaluation model to output quality evaluation sub-information respectively corresponding to the video sub-images, wherein the quality evaluation model comprises a self-attention network with a moving window; and fusing the quality evaluation sub-information respectively corresponding to the video sub-images to obtain quality evaluation information corresponding to the target video.

### BRIEF DESCRIPTION OF THE DRAWINGS

In conjunction with the drawings and with reference to the following specific implementations, the above and other features, advantages and aspects of respective embodiments of the present disclosure will be made more apparent. Throughout the drawings, the same or similar reference symbols represent the same or similar components. It would be appreciated that the drawings are provided illustratively, where the components and elements are not necessarily drawn to scale.

FIG. 1 illustrates a flowchart of a video quality evaluation method provided by embodiments of the present disclosure;

FIG. 2 illustrates a schematic diagram of a structure of a quality evaluation model provided by embodiments of the present disclosure;

FIG. 3 illustrates a schematic diagram of evaluating quality of a target video provided by embodiments of the present disclosure;

FIG. 4 illustrates a schematic diagram of a structure of a video quality evaluation apparatus provided by embodiments of the present disclosure; and

FIG. 5 illustrates a schematic diagram of a structure of an electronic device provided by embodiments of the present disclosure.

### DETAILED DESCRIPTION OF EMBODIMENTS

Reference now will be made to the drawings to describe the embodiments of the present disclosure. However, the present disclosure could be implemented in various forms, which should not be construed as being limited to those embodiments illustrated herein. Rather, those embodiments are provided to enable a more thorough and complete understanding on the present disclosure. It would be appreciated that the drawings and embodiments of the present disclosure are provided exemplarily, without suggesting any limitation to the protection scope of the present disclosure.

It is to be understood that respective steps in the implementations of the method according to the present disclosure may be performed in different orders and/or performed in parallel. In addition, the method implementations may include additional steps and/or steps omitted. The scope of the present disclosure is not limited in the aspect.

As used herein, the term “includes” and its variants are to be read as open-ended terms that mean “includes, but is not limited to.” The term “based on” is to be read as “based at least in part on.” The term “an embodiment” is to be read as “at least one embodiment;” the term “another embodiment” is to be read as “at least one further embodiment;” the term “some embodiments” is to be read as “at least some embodiments.” Related definitions of other terms will be provided in the description below.

It should be noted that, the terms “first,” “second” and the like mentioned in the present disclosure are only used to distinguish different apparatuses, modules or units, rather than limit an order of functions performed by the apparatus, module or unit or limit interdependence.

It should be noted that, the terms “one” and “a plurality of” mentioned in the present disclosure are illustrative, not restrictive, and should be understood as “one or more” by those skilled in the art, unless explicitly specified otherwise in the context.

Names of messages or information interacted between a plurality of apparatuses in the embodiments of the present disclosure are illustrative rather than limit the scope of the messages or information.

Prior to applying the technical solution according to various embodiments of the present disclosure, the user should be informed of the type, scope of use, and use scenario of the personal information involved in an appropriate manner, and user authorization should be obtained.

For example, in response to receiving an active request from a user, prompt information is sent to the user to explicitly inform the user that the requested operation would acquire and use the user's personal information. Therefore, according to the prompt information, the user may decide on his/her own whether to provide the personal information to software or hardware, such as electronic devices, applications, servers or storage media that perform operations of the technical solution of the present disclosure.

As an optional implementation, without limitation, in response to receiving an active request from a user, the method of sending prompt information to the user may, for example, include a pop-up window, where the prompt information may be presented in the form of text in the pop-up window. In addition, the pop-up window may also carry a select control for the user to choose to “agree” or “disagree” to provide the personal information to the electronic device.

The above process of notifying and obtaining the user authorization is only illustrative, and other methods compliant with the provisions of the relevant laws and regulations can also be applied to the implementations of the present disclosure.

The data (including data per se, and acquisition or application of the data) involved in the present technical solution should comply with the provisions of the corresponding laws and regulations as well as relevant stipulations.

With the rapid iteration and innovation of the media technology, 4K ultra-high definition videos are gradually becoming the trend. A large amount of compression encoding is required for effective transmission of high resolution videos, and the video quality evaluation technology can provide a reliable evaluation criterion for a compressing and encoding operation. Therefore, there is a great demand for quality evaluation techniques for high resolution videos. However, the current common video quality evaluation model is mainly targeted to low resolution videos, and the algorithm is not optimized or designed specifically. In the case, the related algorithm is not sufficiently qualified for evaluating quality of high resolution videos.

According to the prior art, the video quality evaluation model for high resolution videos has the following shortcomings: 1. neglecting time-domain quality characteristics of high resolution videos; 2. neglecting space-domain distortion characteristics of high resolution videos; and 3. failing to optimize a model structure and a training strategy for time and space distortion characteristics of high resolution videos.

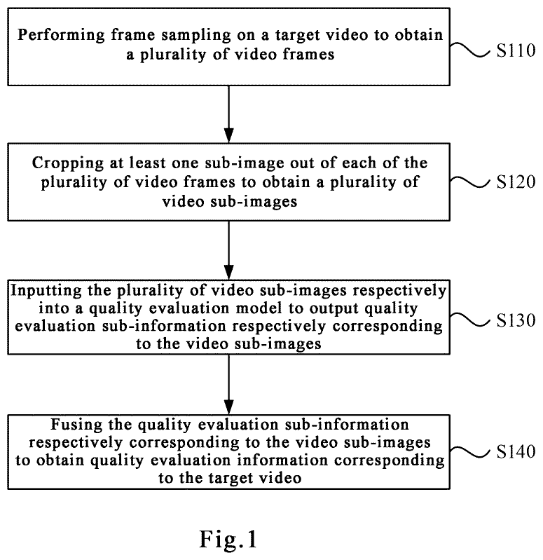

FIG. 1 is a flowchart of a video quality evaluation method provided by embodiments of the present disclosure. The embodiments of the present disclosure can be applied to a scenario of evaluating quality of videos. The method can be performed by a video quality evaluation apparatus, which can be implemented in the form of software and/or hardware, or by an electronic device that may be a mobile terminal, a Personal Computer (PC) or server, or the like.

As shown therein, the method includes:

S110: performing frame sampling on a target video to obtain a plurality of video frames.

The target video may be a video compressed and encoded from a 4K ultra-high definition video with a resolution of 3840×2160. In the embodiments, performing frame sampling on a target video to obtain a plurality of video frames, may be implemented as follows: performing frame sampling on the sample video with a preset sampling frequency to obtain the plurality of video frame samples. The preset sampling frequency may be a frequency set in advance to, for example, 50 frames, 100 frames or the like. By way of example, performing frame sampling on a target video with a frequency of 100 frames may be read as sampling a video frame from every 100 frames.

S120: cropping at least one sub-image out of each of the plurality of video frames to obtain a plurality of video sub-images.

Cropping at least one sub-image out of each of the plurality of video frames may be read as: cropping one or more sub-images out of a video frame. The size of the cropped sub-image is smaller than the size of the video frame.

Alternatively, cropping at least one sub-image out of each of the plurality of video frames may be read as: cropping the plurality of video frames respectively according to a fixed size and a random area scheme to obtain at least one video sub-image corresponding to each video frame.

The fixed size may be an image size within the processing capability of the quality evaluation model, for example, 224×224. The random area scheme may be read as randomly selecting the areas to be cropped from the video frames, i.e., the areas to be cropped of the respective video frames may be the same, or may be different. In these embodiments, presetting a number of cropped sub-images in a video frame includes: first randomly selecting the number of areas from the video frame, and then cropping a sub-image out of each selected area according to the fixed size. By way of example, assumed that the number is set to 3 and the fixed size is 224×224, 3 areas are randomly selected from each video frame, and then, a 224×224 sub-image is cropped out of each of the 3 areas to thus obtain 3 video sub-images corresponding to the video frame.

S130: inputting the plurality of video sub-images respectively into the quality evaluation model to output quality evaluation sub-information respectively corresponding to the video sub-images.

The quality evaluation model includes self-attention networks with moving windows. The quality evaluation model may be a neural network model pre-trained for evaluating ultra-high definition videos.

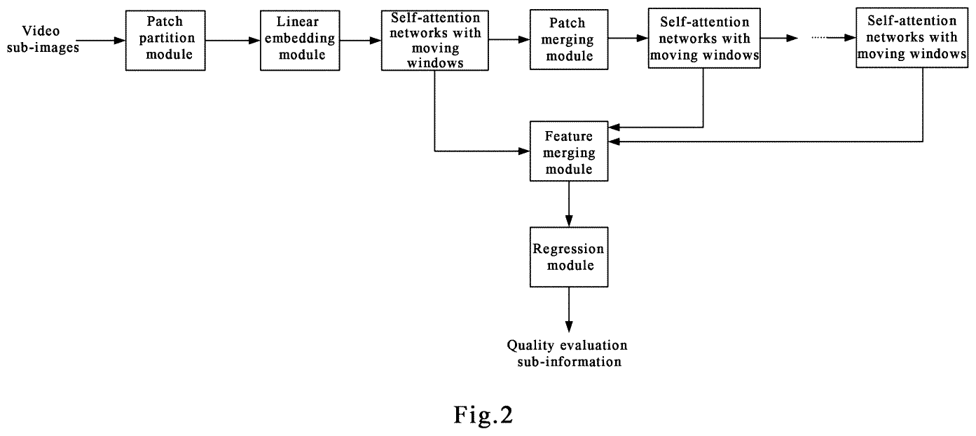

FIG. 2 illustrates a schematic diagram of a structure of a quality evaluation model provided by embodiments of the present disclosure. As shown therein, the quality evaluation model includes a plurality of cascaded self-attention networks with moving windows, a feature merging module and a regression module. Alternatively, as shown therein, the quality evaluation model further includes a patch partition module, a linear embedding module and a patch merging module disposed between two adjacent self-attention networks with moving windows.

The patch partition module is connected with the linear embedding module, the linear embedding module is connected with a first self-attention network with a moving window, an output of the plurality of cascaded self-attention networks with moving windows is connected with the feature merging module, and the self-attention networks with moving windows include at least two serially connected self-attention blocks with moving windows. For the internal structure of the self-attention block with moving windows, see the existing open-source self-attention model with moving windows, and this is not limited herein.

In these embodiments, the number of the self-attention networks with moving windows may be two or more, for example, 4. Specifically: the patch partition module is configured for performing patch partitioning on the input video sub-images; the linear embedding module is configured for performing linear feature embedding on partitioned patches; the self-attention networks with moving windows are configured for performing feature extraction on input data; the patch merging module is configured for performing patch merging processing on features output by the self-attention networks with moving windows; the feature merging module is configured for concatenating features output by the plurality of self-attention networks with after size transformation of the features; and the regression module is configured for performing regression processing on the concatenated features in terms of the quality evaluation information. For the data processing implemented by the patch partition module, the linear regression module, the self-attention networks with moving networks, the patch merging module, the feature merging module and the regression module, see the details about the existing open-source self-attention model with moving windows, and this is not limited herein.

The quality evaluation sub-information can be characterized by an evaluation score. The information may characterize distortion of a video sub-image in two dimensions including a time domain and a space domain, and the information is inversely proportional to the distortion, i.e., a higher score corresponding to the quality evaluation sub-information indicates less distortion of the video sub-image in the time domain and the space domain.

S140: fusing the quality evaluation sub-information respectively corresponding to the video sub-images to obtain quality evaluation information corresponding to the target video.

Fusing the quality evaluation sub-information respectively corresponding to the video sub-images may be implemented as follows: weighting and summing (e.g. averaging) quality evaluation sub-information respectively corresponding to the video sub-images to obtain quality evaluation information of the target video (i.e., a quality evaluation score of the target video).

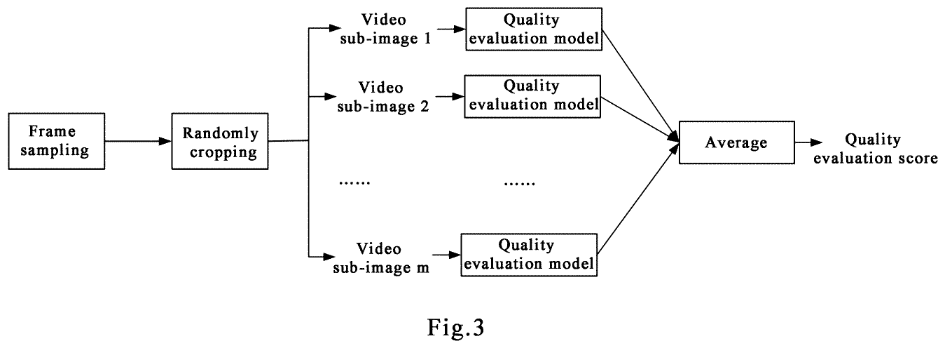

FIG. 3 illustrates a schematic diagram of evaluating quality of a target video according to these embodiments. As shown therein, videos are sampled for a target video; random cropping is performed on the sampled video frames to obtain m video sub-images; inputting m video sub-images into a trained quality evaluation model, respectively to obtain respective quality evaluation scores corresponding to the m video sub-images; averaging the m quality evaluation scores to obtain a quality evaluation score of the target video.

The technical solution according to the embodiments of the present disclosure include: performing frame sampling on a target video to obtain a plurality of video frames; cropping at least one sub-image out of each of the plurality of video frames to obtain a plurality of video sub-images; inputting the plurality of video sub-images respectively into a quality evaluation model to output quality evaluation sub-information respectively corresponding to the video sub-images, wherein the quality evaluation model comprises a self-attention network with a moving window; and fusing the quality evaluation sub-information respectively corresponding to the video sub-images to obtain quality evaluation information corresponding to the target video. With the video quality evaluation method provided by embodiments of the present disclosure (including: performing frame sampling on a target video, cropping the video frames and inputting sub-images obtained by cropping into a quality evaluation model for quality evaluation to thus obtain quality evaluation information of the target video), video quality can be evaluated from the two aspects, namely the time domain and the space domain, such that the quality evaluation information can simultaneously reflect distortion in terms of the time domain and the space domain, thereby improving the video evaluation accuracy and reliability.

Alternatively, training the quality evaluation model may include: performing frame sampling on a video sample to obtain a plurality of video frame samples; cropping at least one sub-image out of each of the plurality of video frames to obtain a plurality of video sub-image samples; inputting the plurality of video sub-images into a quality evaluation model to output predicted quality evaluation information respectively corresponding to the video sub-image samples; and training, based on the predicted quality evaluation information, the quality evaluation model.

The video samples may be a video compressed and encoded from a 4K ultra-high definition video. Specifically, performing frame sampling on a video sample to obtain the plurality of video frame samples may be implemented as follows: performing frame sampling on the sample video with a preset sampling frequency to obtain the plurality of video frame samples.

In these embodiments, in order to increase the number of samples, the sampling frequency for a video sample may be less than the sampling frequency for a target video. For example, the sampling frequency for a video sample may be set to 1 frame, i.e., a sample can be obtained every frame of the video sample. Since time-domain quality of a high definition video is relatively stable, the model training can be performed per video frame to thus expand the size of the training dataset and further improve the inference speed.

In these embodiments, cropping at least one sub-image out of each of the plurality of video frame samples may include: cropping the plurality of video frames respectively according to a fixed size and a random area scheme to obtain at least one video sub-image corresponding to each video frame.

The fixed size may be an image size within the processing capability of the quality evaluation model, for example, 224×224. The random area scheme may be read as randomly selecting the areas to be cropped from the video frame sample, i.e., the areas to be cropped of the respective video frames may be the same, or may be different. See the embodiments described above for the specific process which is omitted herein for brevity.

The quality evaluation model includes: a patch partition module, a linear embedding module, a plurality of cascaded self-attention blocks with moving windows, a patch merging module disposed between two adjacent self-attention blocks with moving windows, a feature merging module and a regression module. For the processing process of the quality evaluation model for video sub-image samples, see the processing process for the video sub-images according to the embodiments described above, and this is omitted herein for brevity.

Training, based on the predicted quality evaluation information, the quality evaluation model may include: determining a loss function based on real quality evaluation information and the predicted quality evaluation information of the plurality of video sub-image samples; and training the quality evaluation model based on the loss function.

The real quality evaluation information of the video sub-image samples may be a real evaluation score of the video sample corresponding thereto. The loss function may be a SmoothLoss function, which is not limited herein. Training, based on the loss function, the quality evaluation model may be read as: performing, based on the loss function, reverse gradient adjustment for the quality evaluation model.

In these embodiments, frames are sampled for a video sample to obtain a plurality of video frame samples; at least one sub-image is cropped out of each of the plurality of video frame samples to obtain a plurality of video sub-image samples; the plurality of sub-image samples is input into a quality evaluation model to output predicted quality evaluation information respectively corresponding to the video sub-image samples; the quality evaluation model is trained based on the predicted quality evaluation information. In this way, the accuracy of the quality evaluation model can be improved.

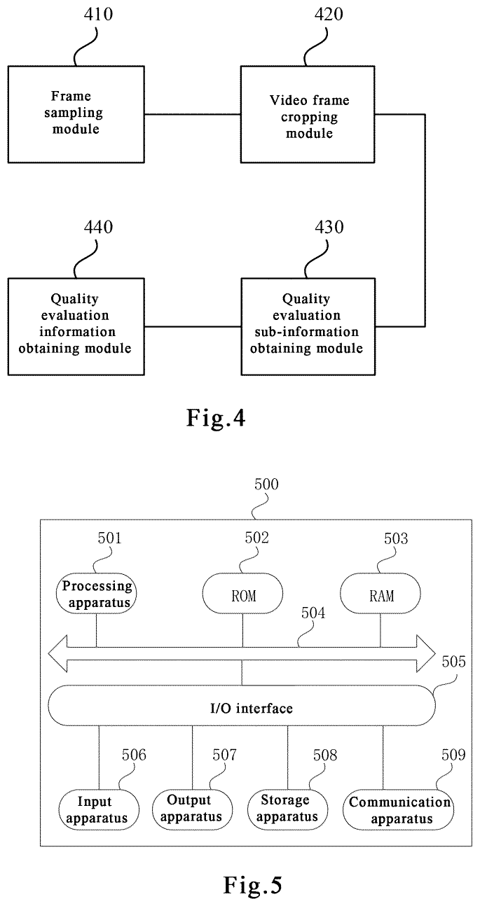

FIG. 4 illustrates a schematic diagram of a video quality evaluation apparatus provided by embodiments of the present disclosure. As shown therein, the apparatus includes:
a frame sampling module 410 for performing frame sampling on a target video to obtain a plurality of video frames;
a video frame cropping module 420 for cropping at least one sub-image out of each of the plurality of video frames to obtain a plurality of video sub-images;
a quality evaluation sub-information obtaining module 430 for inputting the plurality of video sub-images respectively into a quality evaluation model to output quality evaluation sub-information respectively corresponding to the video sub-images, wherein the quality evaluation model comprises a self-attention network with a moving window; and
a quality evaluation information obtaining module 440 for fusing the quality evaluation sub-information respectively corresponding to the video sub-images to obtain quality evaluation information corresponding to the target video.

Alternatively, the video frame cropping module 420 is further configured for:
cropping the plurality of video frames respectively according to a fixed size and a random area scheme to obtain at least one video sub-image corresponding to each video frame.

Alternatively, the quality evaluation model includes a plurality of cascaded self-attention networks with moving windows, a feature merging module and a regression module, wherein an output of the plurality of cascaded self-attention networks with moving windows is connected with the feature merging module, and the self-attention networks with moving windows include at least two serially connected self-attention blocks with moving windows;
the self-attention networks with moving windows are configured for performing feature extraction on input data, the feature merging module is configured for concatenating features output by the plurality of self-attention networks with moving windows after size transformation of the features, and the regression module is configured for performing regression processing on the concatenated features in terms of the quality evaluation information.

Alternatively, the quality evaluation model further comprises: a patch partition module, a linear embedding module and a patch merging module disposed between two adjacent self-attention networks with moving windows;
the patch partition module is connected with the linear embedding module, and the linear embedding module is connected with a first self-attention network with a moving window;
the patch partition module is configured for performing patch partitioning on the input video sub-images, the linear embedding module is configured for performing linear feature embedding on partitioned patches, and the patch merging module is configured for performing patch merging processing on features output by the self-attention networks with moving windows.

Alternatively, the apparatus further includes: a quality evaluation model training block for:
performing frame sampling on a video sample to obtain a plurality of video frame samples;
cropping at least one sub-image out of each of the plurality of video frames to obtain a plurality of video sub-image samples;
inputting the plurality of video sub-images into a quality evaluation model to output predicted quality evaluation information respectively corresponding to the video sub-image samples; and
training, based on the predicted quality evaluation information, the quality evaluation model.

Alternatively, the quality evaluation model training block is further configured for:
performing frame sampling on the sample video with a preset sampling frequency to obtain the plurality of video frame samples.

Alternatively, the quality evaluation model training block is configured for:
determining a loss function based on real quality evaluation information and the predicted quality evaluation information of the plurality of video sub-image samples; and
training the quality evaluation model based on the loss function.

The video quality evaluation apparatus provided by the embodiments of the present disclosure can perform the video quality evaluation method provided by any of the embodiments of the present disclosure, which includes functional blocks corresponding to the method and can achieve the corresponding effects.

A plurality of units and blocks included in the above-mentioned apparatus is divided according to the functional logic, which are not confined to the above division as long as they can implement the respective functions. In addition, names of the plurality of functional units are employed only for differentiation from one another, without suggesting any limitation to the protection scope of the embodiments of the present disclosure.

FIG. 5 illustrates a schematic diagram of a structure of an electronic device provided by embodiments of the present disclosure. Hereinafter, reference will be made to FIG. 5 that illustrates a schematic diagram of a structure of an electronic device (e.g. a terminal device or server in FIG. 5) 500 adapted to implement embodiments of the present disclosure. The terminal device according to the embodiments of the present disclosure may include a mobile terminal such as a mobile phone, a laptop computer, a digital broadcast receiver, a Personal Digital Assistant (PDA), a Portable Android Device (PAD), a Portable Media Player (PMP), an on-vehicle terminal (e.g. an on-vehicle navigation terminal) or the like, or a fixed terminal such as a digital television (TV), a desktop computer or the like. The electronic device 500 as shown in FIG. 5 is provided merely as an example, without suggesting any limitation to the functions and the application range of the embodiments of the present disclosure.

As shown therein, the electronic device 500 may include a processing apparatus (e.g. a central processor, a graphics processor or the like) 501, which can execute various acts and processing based on programs stored in a Read Only Memory (ROM) 502 or a program loaded from a storage apparatus 508 to a Random Access Memory (RAM) 503. RAM 503 stores therein various programs and data required for operations of the electronic device 500. The processing apparatus 501, the ROM 502 and the RAM 503 are connected to one another via a bus 504. An input/output (I/O) interface 505 is also connected to the bus 504.

Typically, the following units may be connected to the I/O interface 505: an input apparatus 506 including, for example, a touchscreen, a touch pad, a keyboard, a mouse, a camera, a microphone, an accelerometer, a gyroscope and the like; an output apparatus 507 including, for example, a Liquid Crystal Display (LCD), a loudspeaker, a vibrator and the like; a storage apparatus 508 including, for example, a tape, a hard drive and the like; and a communication apparatus 509. The communication apparatus 509 can allow wireless or wired communication of the electronic device 500 with other devices to exchange data. Although FIG. 5 shows the electronic device 500 including various units, it would be appreciated that not all of the units as shown are required to be implemented or provided. Alternatively, more or fewer units may be implemented or provided.

In particular, according to embodiments of the present disclosure, the processes described above with reference to the flowchart may be implemented as a computer software program. For example, embodiments of the present disclosure include a computer program product comprising computer programs carried on a non-transitory computer readable medium, the computer program containing program code for performing the method as shown in the flowchart. In those embodiments, the computer program may be downloaded and installed from a network via the communication apparatus 509, or may be installed from the storage apparatus 508, or may be installed from the ROM 502. The computer program, when executed by the processing apparatus 501, performs the above-described functions defined in the method according to the embodiments of the present disclosure.

Names of messages or information interacted between a plurality of apparatuses in the embodiments of the present disclosure are illustrative rather than limit the scope of the messages or information.

The electronic device provided by the embodiments of the present disclosure belongs to the same invention conception as the image processing method provided by the above-mentioned embodiments. For the technical details not exhausted here, see the above-mentioned embodiments, and these embodiments can achieve the same advantageous effect as the above-mentioned embodiments.

The embodiments of the present disclosure provide a computer storage medium having a computer program stored thereon, where the program, when executed by a processor, implements the video quality evaluation method provided by the above-mentioned embodiments.

The computer readable medium according to the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, an RAM, an ROM, an erasable programmable read-only memory (EPROM or flash memory), an optical fiber, a portable compact disc read-only memory (CD-ROM), an optical storage device, a magnetic storage device, or any suitable combination of the foregoing. In the present disclosure, a computer readable storage medium may be any tangible medium that can contain, or store, a program for use by or in connection with an instruction execution system, apparatus, or device. In contrast, in the present disclosure, a computer readable signal medium may include a propagated data signal with computer readable program code embodied therein, either in baseband or as part of a carrier wave. Such propagated data signal may take many forms, including, but not limited to, an electro-magnetic signal, an optical signal, or any suitable combination thereof. A computer readable signal medium may also be any computer readable medium that is not a computer readable storage medium and that can communicate, propagate, or transmit a program for use by or in connection with an instruction execution system, apparatus, or device. Program code embodied on a computer readable medium may be transmitted using any appropriate medium, including but not limited to: electrical wires, optical cables, RF (radio frequency), etc., or any suitable combination of the foregoing.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example, the internet), a peer-to-peer network (e.g. ad hoc peer-to-peer network), and any known network or network to be developed.

The computer-readable medium may be the one included in the electronic device, or may be provided separately, rather than assembled in the electronic device.

The computer-readable medium carries one or more programs which, when executed by the electronic device, cause the electronic device to: perform frame sampling on a target video to obtain a plurality of video frames; crop at least one sub-image out of each of the plurality of video frames to obtain a plurality of video sub-images; input the plurality of video sub-images respectively into a quality evaluation model to output quality evaluation sub-information respectively corresponding to the video sub-images, wherein the quality evaluation model comprises a self-attention network with a moving window; and merge the quality evaluation sub-information respectively corresponding to the video sub-images to obtain quality evaluation information corresponding to the target video.

Computer program code for performing operations of the present disclosure may be written by using one or more program design language or any combination. The program design language includes, but is not limited to, object oriented program design language such as Java, Smalltalk and C++, and further includes conventional process-type program design language such as “C” or similar program design language. The program code may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowchart and block diagrams in the drawings illustrate the architecture, functionality and operation of possible implementations of systems, methods and computer program products according to various embodiments of the present disclosure. In this regard, each block in the flowchart or block diagrams may represent a block, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

Related units for describing the embodiments of the present disclosure may be implemented in the form of software, or may be implemented in the form of hardware. In certain circumstances, the names of units/blocks do not formulate limitation to the units per se. For example, the first obtaining unit may be described as “a unit for obtaining at least two Internet Protocol Addresses.”

The functions described above may be performed, at least in part, by one or more hardware logic components. For example, without limitation, exemplary types of hardware logic components that may be used include: Field Programmable Gate Arrays (FPGAs), Application Specific Integrated Circuits (ASICs), Application Specific Standard Products (ASSPs), Systems on Chip (SOCs), Complex Programmable Logic Devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of a computer-readable storage medium would include an electrical connection based on one or more wires, a portable computer diskette, a hard disk, an RAM, an ROM, an EPROM or flash memory, an optical fiber, a CD-ROM, an optical storage device, a magnetic storage device, or any suitable combination of the foregoing.

Above described are only optimal embodiments of the present disclosure and the technical principles applied therein. It would be appreciated by those skilled in the art that the scope of the disclosure herein is not limited to the particular combination of features described above, but also encompasses other embodiments in which any combination of the features described above or their equivalents does not depart from the spirit of the disclosure. For example, the above features and (but not limited to) the features disclosed in this disclosure having similar functions are replaced with each other to form the technical solution.

Further, while operations are depicted in a particular order, this should not be understood as requiring that such operations be performed in the particular order shown or in sequential order. In certain circumstances, multitasking and parallel processing may be advantageous. Likewise, while several specific implementation details are contained in the above discussions, these should not be construed as limitations on the scope of the present disclosure, but rather as descriptions of features that may be specific to particular implementations. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure specified in the appended claims is not necessarily limited to the specific features or acts described above. Rather, the specific features and acts described above are disclosed as example forms of implementing the claims.

I/we claim:

1. A method for evaluating video quality, comprising:
performing frame sampling on a target video to obtain a plurality of video frames;
cropping at least one sub-image out of each of the plurality of video frames to obtain a plurality of video sub-images;
inputting the plurality of video sub-images respectively into a quality evaluation model to output quality evaluation sub-information respectively corresponding to the video sub-images, wherein the quality evaluation model comprises a self-attention network with a moving window; and
fusing the quality evaluation sub-information respectively corresponding to the video sub-images to obtain quality evaluation information corresponding to the target video.

2. The method of claim 1, wherein cropping the at least one sub-image out of each of the plurality of video frames comprises:
cropping the plurality of video frames respectively according to a fixed size and a random area scheme to obtain at least one video sub-image corresponding to each video frame.

3. The method of claim 1, wherein the quality evaluation model comprises a plurality of cascaded self-attention networks with moving windows, a feature merging module and a regression module, wherein an output of the plurality of cascaded self-attention networks with moving windows is connected with the feature merging module, and the self-attention networks with moving windows comprise at least two serially connected self-attention blocks with moving windows; and
the self-attention networks with moving windows are configured for performing feature extraction on input data, the feature merging module is configured for concatenating features output by the plurality of self-attention networks with moving windows after size transformation of the features, and the regression module is configured for performing regression processing on the concatenated features in terms of the quality evaluation information.

4. The method of claim 3, wherein the quality evaluation model further comprises: a patch partition module, a linear embedding module, and a patch merging module disposed between two adjacent self-attention networks with moving windows;
wherein the patch partition module is connected with the linear embedding module, and the linear embedding module is connected with a first self-attention network with a moving window; and
the patch partition module is configured for performing patch partitioning on the input video sub-images, the linear embedding module is configured for performing linear feature embedding on partitioned patches, and the patch merging module is configured for performing patch merging processing on features output by the self-attention networks with moving windows.

5. The method of claim 1, wherein a training method of the quality evaluation model comprises:
performing frame sampling on a video sample to obtain a plurality of video frame samples;
cropping at least one sub-image out of each of the plurality of video frames to obtain a plurality of video sub-image samples;
inputting the plurality of video sub-image samples into a quality evaluation model to output predicted quality evaluation information respectively corresponding to the video sub-image samples; and
training, based on the predicted quality evaluation information, the quality evaluation model.

6. The method of claim 5, wherein sampling the frames for the video sample to obtain the plurality of video frame samples, comprises:
performing frame sampling on the sample video with a preset sampling frequency to obtain the plurality of video frame samples.

7. The method of claim 5, wherein training, based on the predicted quality evaluation information, the quality evaluation model comprises:
determining a loss function based on real quality evaluation information and the predicted quality evaluation information of the plurality of video sub-image samples; and
training the quality evaluation model based on the loss function.

8. An electronic device, comprising:
one or more processors; and
a memory configured to store one or more programs;
wherein the one or more programs, when executed by the one or more processors, cause the one or more processors to implement a video quality evaluation method comprising:
performing frame sampling on a target video to obtain a plurality of video frames;
cropping at least one sub-image out of each of the plurality of video frames to obtain a plurality of video sub-images;
inputting the plurality of video sub-images respectively into a quality evaluation model to output quality evaluation sub-information respectively corresponding to the video sub-images, wherein the quality evaluation model comprises a self-attention network with a moving window; and
fusing the quality evaluation sub-information respectively corresponding to the video sub-images to obtain quality evaluation information corresponding to the target video.

9. The electronic device of claim 8, wherein cropping the at least one sub-image out of each of the plurality of video frames comprises:
cropping the plurality of video frames respectively according to a fixed size and a random area scheme to obtain at least one video sub-image corresponding to each video frame.

10. The electronic device of claim 8, wherein the quality evaluation model comprises a plurality of cascaded self-attention networks with moving windows, a feature merging module and a regression module, wherein an output of the plurality of cascaded self-attention networks with moving windows is connected with the feature merging module, and the self-attention networks with moving windows comprise at least two serially connected self-attention blocks with moving windows; and
the self-attention networks with moving windows are configured for performing feature extraction on input data, the feature merging module is configured for concatenating features output by the plurality of self-attention networks with moving windows after size transformation of the features, and the regression module is configured for performing regression processing on the concatenated features in terms of the quality evaluation information.

11. The electronic device of claim 10, wherein the quality evaluation model further comprises: a patch partition module, a linear embedding module, and a patch merging module disposed between two adjacent self-attention networks with moving windows;
wherein the patch partition module is connected with the linear embedding module, and the linear embedding module is connected with a first self-attention network with a moving window; and
the patch partition module is configured for performing patch partitioning on the input video sub-images, the linear embedding module is configured for performing linear feature embedding on partitioned patches, and the patch merging module is configured for performing patch merging processing on features output by the self-attention networks with moving windows.

12. The electronic device of claim 8, wherein a training method of the quality evaluation model comprises:
performing frame sampling on a video sample to obtain a plurality of video frame samples;
cropping at least one sub-image out of each of the plurality of video frames to obtain a plurality of video sub-image samples;
inputting the plurality of video sub-image samples into a quality evaluation model to output predicted quality evaluation information respectively corresponding to the video sub-image samples; and
training, based on the predicted quality evaluation information, the quality evaluation model.

13. The electronic device of claim 12, wherein sampling the frames for the video sample to obtain the plurality of video frame samples, comprises:
performing frame sampling on the sample video with a preset sampling frequency to obtain the plurality of video frame samples.

14. The electronic device of claim 12, wherein training, based on the predicted quality evaluation information, the quality evaluation model comprises:
determining a loss function based on real quality evaluation information and the predicted quality evaluation information of the plurality of video sub-image samples; and
training the quality evaluation model based on the loss function.

15. A non-transitory storage medium comprising computer executable instructions which, when executed by a computer processor, perform a video quality evaluation method comprising:
performing frame sampling on a target video to obtain a plurality of video frames;
cropping at least one sub-image out of each of the plurality of video frames to obtain a plurality of video sub-images;
inputting the plurality of video sub-images respectively into a quality evaluation model to output quality evaluation sub-information respectively corresponding to the video sub-images, wherein the quality evaluation model comprises a self-attention network with a moving window; and
fusing the quality evaluation sub-information respectively corresponding to the video sub-images to obtain quality evaluation information corresponding to the target video.

16. The non-transitory storage medium of claim 15, wherein cropping the at least one sub-image out of each of the plurality of video frames comprises:
cropping the plurality of video frames respectively according to a fixed size and a random area scheme to obtain at least one video sub-image corresponding to each video frame.

17. The non-transitory storage medium of claim 15, wherein the quality evaluation model comprises a plurality of cascaded self-attention networks with moving windows, a feature merging module and a regression module, wherein an output of the plurality of cascaded self-attention networks with moving windows is connected with the feature merging module, and the self-attention networks with moving windows comprise at least two serially connected self-attention blocks with moving windows; and
the self-attention networks with moving windows are configured for performing feature extraction on input data, the feature merging module is configured for concatenating features output by the plurality of self-attention networks with moving windows after size transformation of the features, and the regression module is configured for performing regression processing on the concatenated features in terms of the quality evaluation information.

18. The non-transitory storage medium of claim 17, wherein the quality evaluation model further comprises: a patch partition module, a linear embedding module, and a patch merging module disposed between two adjacent self-attention networks with moving windows;
wherein the patch partition module is connected with the linear embedding module, and the linear embedding module is connected with a first self-attention network with a moving window; and
the patch partition module is configured for performing patch partitioning on the input video sub-images, the linear embedding module is configured for performing linear feature embedding on partitioned patches, and the patch merging module is configured for performing patch merging processing on features output by the self-attention networks with moving windows.

19. The non-transitory storage medium of claim 15, wherein a training method of the quality evaluation model comprises:
performing frame sampling on a video sample to obtain a plurality of video frame samples;
cropping at least one sub-image out of each of the plurality of video frames to obtain a plurality of video sub-image samples;
inputting the plurality of video sub-image samples into a quality evaluation model to output predicted quality evaluation information respectively corresponding to the video sub-image samples; and
training, based on the predicted quality evaluation information, the quality evaluation model.

20. The non-transitory storage medium of claim 19, wherein sampling the frames for the video sample to obtain the plurality of video frame samples, comprises:
performing frame sampling on the sample video with a preset sampling frequency to obtain the plurality of video frame samples.
